(19) United States
(12) Patent Application Publication
(10) Pub. No.: US 2009/0026160 A1
(43) Pub. Date: Jan. 29, 2009

(54) Casket Display Apparatuses, Systems, and Methods

(76) Inventors: David F. Wright, Cameron, TX (US); Vicki B. Goza, Cameron, TX (US)

Correspondence Address: SCHUBERT OSTERRIEDER & NICKELSON PLLC, 6013 CANNON MTN DR, S14, AUSTIN, TX, 78749, US

(21) Appl. No.: 12/167,511

(22) Filed: Jul. 3, 2008

Related U.S. Application Data
(60) Provisional application No. 60/952,500, filed on Jul. 27, 2007.

(51) Int. Cl. A61G 17/00

(52) U.S. Cl. 211/85.16

(57) ABSTRACT

Apparatuses, systems, and methods for displaying caskets, such as displaying caskets during church or burial services, are disclosed. One embodiment comprises a method of presenting a casket for display, which involves supporting the casket with a mechanical structure and placing an assemblage of panels around a portion of the mechanical structure. Some embodiments may include unfolding the assemblage of panels before placing it, folding the assemblage to allow transport of the assemblage, supporting the casket above the ground elevation by using a casket truck, and/or placing the assemblage of panels by rolling it on casters. Another embodiment comprises an apparatus for displaying a casket. The apparatus may have a front panel and one or more wing panels attached to the front panel via hinges. The hinges may also allow the wing panels to swing toward the front panel and collapse for transporting the apparatus. One or more alternative embodiments may have casters attached to one or more of the panels to allow the apparatus to roll on a floor or the ground.

### FIELD

The present invention generally relates to the field of funeral equipment. More particularly, the present invention relates to apparatuses, systems, and methods for displaying caskets.

### BACKGROUND

When people attend funeral visitation and graveside services for their loved ones, aesthetic appearances of the caskets, biers, and other funeral equipment are usually of paramount importance to family members, friends, and acquaintances of the departed. People do not want to see the casket trucks or other mechanical contraptions which support the caskets. People desire elegance and beauty.

Several casket display options currently exist for funeral directors. Caskets may be mounted on a variety of different casket support assemblies, such as pedestals, show-room trucks, biers, church trucks, casket trucks, or other mechanical devices. A funeral director may hang a fabric skirt around the casket support assembly. The skirts are considered by many to be less classy and inferior to other more aesthetically pleasing solutions, such as decorative and ornate wooden panels.

The casket bier provides an alternative to the fabric skirt. Funeral directors have long used casket biers, as they have the elegance that people routinely seek. Unfortunately, casket biers are extremely expensive and very unwieldy to move around, with or without a casket on them. The casket biers generally cannot easily be transported between locations, such as between a funeral home, church, and a cemetery. Plus, the use of casket biers generally requires the caskets to be lifted numerous times, increasing the likelihood of injuries to those moving the caskets between the casket biers and church trucks.

### BRIEF DESCRIPTION OF THE DRAWINGS

Aspects of the embodiments will become apparent upon reading the following detailed description and upon reference to the accompanying drawings in which like references may indicate similar elements:

FIG. 1 depicts one embodiment of a casket display apparatus;

FIG. 2 illustrates how wing panels of an assemblage of panels may rotate between an open position and a closed position;

FIG. 3 shows a folded rear view of an alternative embodiment of a casket display apparatus;

FIG. 4 displays a rear perspective view of an embodiment of a casket display apparatus;

FIGS. 5A-5F depict various components for one or more embodiments of a casket display apparatus;

FIG. 6 shows how a person may carry a collapsed casket display apparatus;

FIGS. 7A&7B illustrate how an embodiment of a casket display apparatus or system may conceal a mechanical structure supporting a casket; and

FIG. 8 illustrates one method of using an assemblage of panels to hide a mechanical structure supporting a casket.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions that follow are designed to make such embodiments obvious to a person of ordinary skill in the art.

Generally speaking, the present invention relates to apparatuses, systems, and methods for displaying caskets, such as displaying caskets during church or burial services. One embodiment comprises a method of presenting a casket for display. The method comprises supporting the casket above a ground elevation via a mechanical structure and placing an assemblage of panels around a portion of the mechanical structure. Some embodiments may include unfolding the assemblage of panels before placing it. In one or more embodiments, unfolding the panels may involve moving one or more wing panels about one or more hinges that couple the wing panels to a front panel. Some embodiments also include folding the assemblage to allow transport of the assemblage, such as after a church service or burial service at a cemetery. Various embodiments may involve supporting the casket above the ground elevation by using a casket truck, such as a casket truck in a church or a funeral home. In numerous embodiments, placing the assemblage of panels may involve rolling it on casters. Placing the assemblage between the mechanical structure and viewers of the casket may help hide or conceal the mechanical structure in various embodiments.

Another embodiment comprises an apparatus for displaying a casket. The apparatus may have a front panel and one or more wing panels attached to the front panel via hinges. The hinges may allow the wing panels to swing away from the front panel so that the apparatus may be placed around a mechanical structure supporting the casket. The hinges may also allow the wing panels to swing toward the front panel and collapse for transporting the apparatus. One or more alternative embodiments may have casters attached to one or more of the panels to allow the apparatus to roll on a floor. Some of such alternative embodiments may have casters that are adjustable, to change the distance between the apparatus and the floor. Various alternative embodiments may employ different types of legs and/or supports. For example, some apparatuses may use feet, legs, threaded feet, threaded legs, or bun feet to support the apparatus above a ground or a floor. One or more embodiments may employ one or more latches to secure wing panels to the front panels. For example, numerous embodiments may employ one or two magnetic catches as latches to secure a wing panel to the front panel.

A further embodiment comprises an apparatus with an assemblage of panels for displaying a casket, wherein the panels may unfold to conceal a mechanical support of the casket from viewers. One or more panels of these embodiments may fold to allow for transport of the assemblage. Numerous embodiments may include one or more fasteners to secure the panels during transport. For examples, some embodiments may employ one or more hook and loop fasteners to secure the panels while other embodiments may employ mechanical or magnetic catches. Some embodiments may use one or more hinges to allow the folding of the panels. Various embodiments may include support members to separate the assemblage from the ground or floor. For example, one embodiment may use one or more casters under each of the panels to support the assemblage above a floor and allow it to roll.

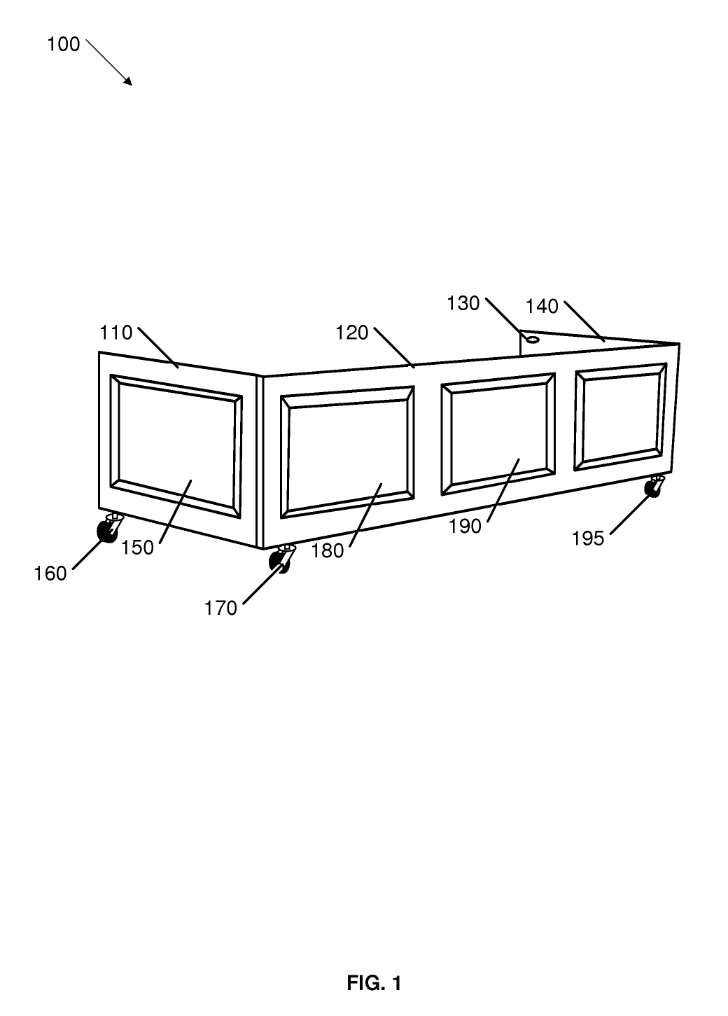

Turning to the drawings, FIG. 1 illustrates one embodiment of a casket display apparatus 100 comprising an assemblage of panels. Casket display apparatus 100 has a front panel 120, a first wing panel 110, and a second wing panel 140. Casket display apparatus 100 may be placed around a casket truck supporting a casket to accentuate the beauty of the casket and hide the casket truck, which may be aesthetically displeasing. Casket display apparatus 100 may also be placed around other mechanical structures or apparatuses supporting a casket, such as wood trusses, concrete blocks or pylons, or even a casket bier.

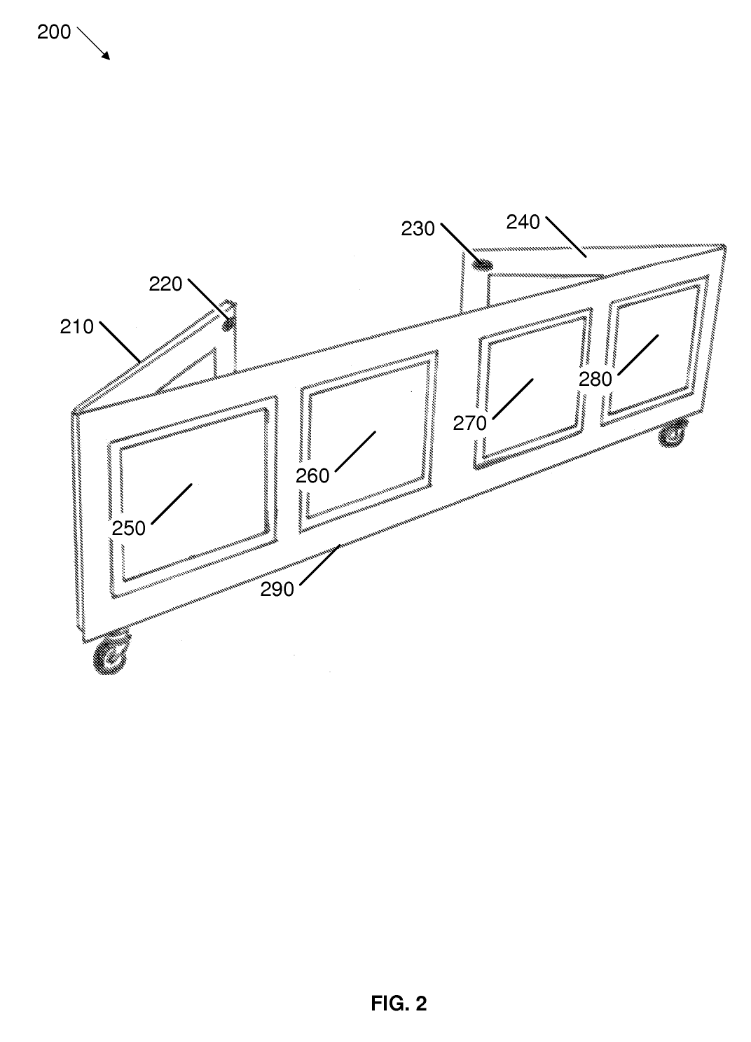

In the specific embodiment shown in FIG. 1, front panel 120 has a three panel inserts, such as panel insert 180 and panel insert 190. Alternative embodiments may have various numbers of panels. For example, the embodiment shown in FIG. 2 has four font panel inserts. More specifically, front panel 290 has a first panel insert 250, a second panel insert 260, a third panel insert 270, and a fourth panel insert 280. Other embodiments may have zero, one, two, five, or more panel inserts. For example, an embodiment may have a front or side panel with no panel inserts. In such embodiments, the panels may have only flat surfaces and optionally include ornate carvings or router etchings to provide decorative appearances.

In the specific embodiment shown in FIG. 1, the edges of the panel inserts are tapered and provide a decorative look. Alternative embodiments may change the appearance of the panels or the panel inserts using a variety of different techniques. For example, some embodiments may use moulding to create a decorative look, attached with brads, nails, screws, or glue. Other embodiments may use one or more decorative router grooves to create an aesthetically pleasing appearance. Additionally, various embodiments may have different surface finishes which create alternative appearances. For example, casket display apparatus 100 may have a stained wood finish, or a stained wood appearance. Other embodiments may have painted surfaces. Further embodiments may have a stained wood appearance but have decorative painted shapes, such as pinstripes or flowers. Even further embodiments may have decorative emblems or lettering affixed to one or more surfaces of casket display apparatus 100. For example, some embodiments may have silver, gold, or brass ornate flowers attached to or inlaid on one or more of the surfaces of casket display apparatus 100.

In FIG. 1, casket display apparatus 100 has four casters, such as caster 160, caster 170, and caster 195, to support casket display apparatus 100 and allow it to roll on a floor. In different embodiments that employ casters for support or elevation, casters may come in different sizes, appearances, materials of construction, and ratings for load bearing. For example, each of the casters for casket display apparatus 100 may comprise a rubber wheel coupled to a chrome-finished support assembly, having an 80 pound rating. Additionally, for the embodiment of casket display apparatus 100 depicted in FIG. 1, each of the casters is screwed into a threaded brass insert that is pre-drilled and then screwed into the bottoms of each of the panels. Alternative embodiments that employ casters may secure the casters to the panels in different ways. For example, one embodiment may have casters with smooth rods which securely and snugly fit inside pre-drilled holes in the bottom of the panels.

As described above, casket display apparatus has wing panel 110 and wing panel 140. In the embodiment shown in FIG. 1, wing panel 110 has a single panel insert 150. Similar to the fashion described above for front panel 120, wing panel 110 and wing panel 140 may have varying numbers of panel inserts, employ various means to create different decorative looks, and have various surface finishes and appearances. For example, wing panel 110 may have four or more panel inserts arranged in a top-to-bottom and left-to-right fashion, such as with panes of glass in a window. Such panes may be created using individual panels inserted into support members in a tongue-and-groove fashion. Alternatively, the appearance of such panes may be created using trim molding secured with brads, screws, or glue.

As will be illustrated in subsequent figures, wing panel 110 and wing panel 140 may collapse and fold inward toward front panel 120. When wing panel 110 and wing panel 140 are folded in toward front panel 120 in a collapsed arrangement, casket display apparatus 100 may be more easily lifted and transported to different locations. To secure wing panel 110 and wing panel 140 during such transports, casket display apparatus 100 employs magnetic catch assemblies. For example, wing panel 140 has two securely attached magnetic catches, such as magnetic catch 130. When wing panel 140 is folded against front panel 120, magnetic catch 130 and the other magnetic catch contact metal strike-plates affixed to front panel 120 and secure second wing panel 140 during transport. While not shown in FIG. 1, wing panel 110 also has two magnetic catch assemblies, as well as associated metal strike-plates affixed to front panel 120.

As noted, the embodiment of casket display apparatus 100 shown in FIG. 1 employs two magnetic catch assemblies for each wing panel. Alternative embodiments may employ varying numbers of different latching mechanisms. For example, an embodiment may employ a hook-and-eye latch assembly to secure a wing panel to another panel. A front panel may have the hook portion insert into the eye portion attached to a wing panel. Alternatively, the hook portion may be on one wing panel while the eye portion is affixed to another wing panel, wherein the hook and eye latch together when wing panels are collapsed are folded toward the front panel.

FIG. 2 illustrates how a wing panel 210 and a wing panel 240 of an assemblage of panels may rotate from between an open position and a fully closed position. Additionally, FIG. 2 illustrates that wing panel 210 has a magnetic catch 220 and wing panel 240 has a magnetic catch 230. While the embodiment shown in FIG. 2 has two magnetic catches, alternative embodiments may have even more or fewer catches. For example, wing panel 240 may have one magnetic catch along its bottom in addition to magnetic catch 230 and wing panel 210 may have an additional magnetic catch along its bottom in addition to magnetic catch 220. Alternatively, in another embodiment, each wing panel may have three or more magnetic catches. For example, additional magnetic catches may be necessary when wing panels are heavy and tend to cause the wing panels to fall open during transport.

Each of the panels of the embodiment of casket display apparatus 200 are made from medium density fiberboard laminated with a cherry-finished wood veneer. Alternative embodiments may be constructed from different materials and have different finishes. For example, some embodiments may have front panel 290, wing panel 210, and wing panel 240 constructed from solid wood. For example, wing panel 210 may be constructed from solid mahogany, pine, teak, or cedar, as examples. Each of the entire panels may be constructed entirely of such solid wood, instead of medium density fiberboard. Alternatively, each of the panels may be made from solid wood and yet also be finished in a wood veneer. For example, wing panel 240 may be constructed from pine but have a birch wood veneer.

Instead of wood, the panels of casket display apparatus 200 may be constructed from other materials in various embodiments. In some embodiments, one or more of the panels may be constructed out of plastic or vinyl. Such plastic panels may be made to simulate or have the appearance of natural wood. Alternatively, such plastic panels may be various colors such as white, black, or brown. In even further embodiments, the panels may be constructed from other materials such as tin or aluminum. Using alternative materials for the panels may allow an embodiment similar to casket display apparatus 200 to have an overall lower weight, making it easier to carry and move. Additionally, the panels may be solid or hollow. For the embodiments having one or more hollowed sections, the hollowed sections may contain a fill material to deaden sound emitted from the sections. For example front panel 290 may be constructed from a vinyl material and have a Styrofoam™ fill.

Hinges may attach the wing or side panels to the front or other panels in various ways in different embodiments. For example, for embodiments having panels made from metal, such as aluminum or galvanized sheet metal, the hinges may be affixed to the panels via welds. Alternatively, the hinges may be glued, formed, crimped, bent, or rivoted to the panels, as examples.

While the embodiment of casket display apparatus 200 depicted in FIG. 2 may have a dark cherry stained finish, alternative embodiments may have different finishes. For example, one embodiment may have a clear coated red oak finish while another embodiment has a walnut finish. In addition to the various colors, the finishes for the panels may also vary from embodiment to embodiment. For example, some embodiments may have a polyurethane or a lacquer finish while other embodiments have only a natural oil or a wax finish.

As mentioned, casket display apparatus 200 has magnetic catches 220 and 230 to secure wing panels 210 and 240, respectively, to front panel 290. In other words, magnetic catches 220 and 230 may adhere or magnetically couple with two metal strike-plates affixed to front panel 290 when wing panels 210 and 240 all are closed or folded to front panel 290. Alternative embodiments may employ alternative fasteners or fastening means to secure the wing panels to the front panel during transport or storage. For example, alternative embodiments may use Velcro® or hook and loop latching means, hook-and-eye latch assemblies, various catch-and-strike assemblies, snap fasteners, pin-and-sleeve assemblies, or other mechanical latching devices to secure panels for transport, such as wing panels 210 and 240 to front panel 290. Additionally, some embodiments may employ no latches or catches at all.

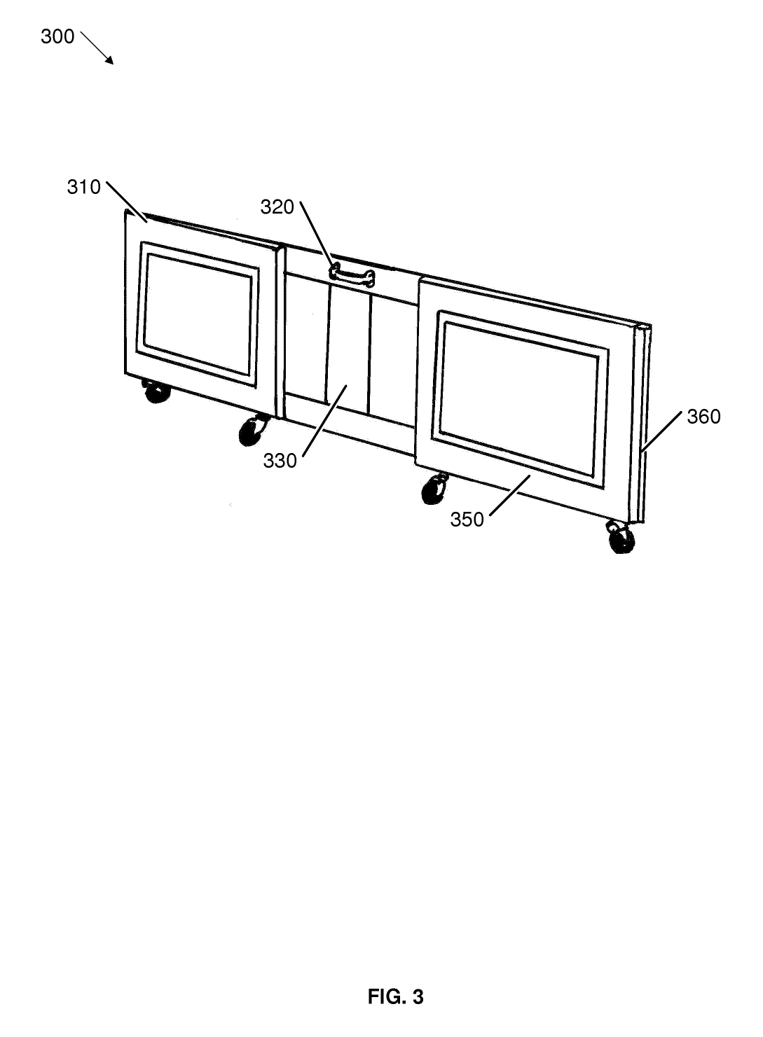

FIG. 3 shows a folded rear view of an alternative embodiment of a casket display apparatus 300, wherein a first side panel 310 and a second side panel 350 are folded and secured to a front panel 330. Once folded in the manner shown in FIG. 3, a person may lift casket display apparatus 300 using handle 320. For the embodiment of casket display apparatus 300, handle 320 is securely affixed to the center of front panel 330 via four wood screws. With handle 320 being centered on front panel 330 in this fashion, casket display apparatus 300 may generally be balanced when a person lifts casket display apparatus 300 off the ground or floor and transports it to another location. Having side panel 310 and side panel 350 folded as illustrated in FIG. 3 may also allow one to store casket display apparatus 300 out of sight, using considerably less space than when opened.

While the embodiment shown in FIG. 3 has a single handle 320, alternative embodiments may have different numbers of handles. For example, some embodiments may have no handles all. Such embodiments may employ a recessed groove, which may be created by a router or other means. A person may insert his or her fingers into the recessed groove to lift casket display apparatus 300 for transport. Other embodiments may employ two or more handles. For example, a casket display apparatus may be constructed from a material which is very heavy and require a least two people to carry. Accordingly, the embodiment may have a first handle located on one end, such as near side panel 350, and a second handle located on the other end, such as near side panel 310. One person on each of the respective ends may lift the end of the casket display apparatus using each of the respective handles. Alternative embodiments may employ a handle similar to handle 320 but without it securely affixed to front panel 330. For example, one embodiment may employ a collapsible handle that folds into panel 330 when the collapsible handle is released. In another embodiment, the handle may be removable and attached to front panel 330 via a locking slot or groove. Even further embodiments may employ varying numbers of such removable or collapsible handles.

As FIG. 3 illustrates, side panel 310 and side panel 350 may be folded and secured to front panel 330. Side panel 350 rotates about a single hinge 360, spanning the distance from the top to the bottom of side panel 350 and front panel 330. In the embodiment of casket display apparatus 300 shown in FIG. 3, hinge 360 is securely affixed to wing panel 350 and front panel 330 via a plurality of small wood screws. As noted, hinge 360 may comprise a single continuous hinge running from the top to the bottom of both front panel 330 and side panel 350. Running from the top to the bottom in this manner, hinge 360 may provide a strong and firm joint for long-lasting durability. In alternative embodiments, the folding means may comprise multiple hinges coupling side panel 350 to front panel 330. For example, an alternative embodiment may employ a first hinge near the top of side panel 350 and employ a second hinge near the bottom of side panel 350. Other embodiments may employ three or more hinges. While not clearly shown for the embodiment of casket display apparatus 300 in FIG. 3, side panel 310 is attached to front panel 330 using a hinge similar to hinge 360.

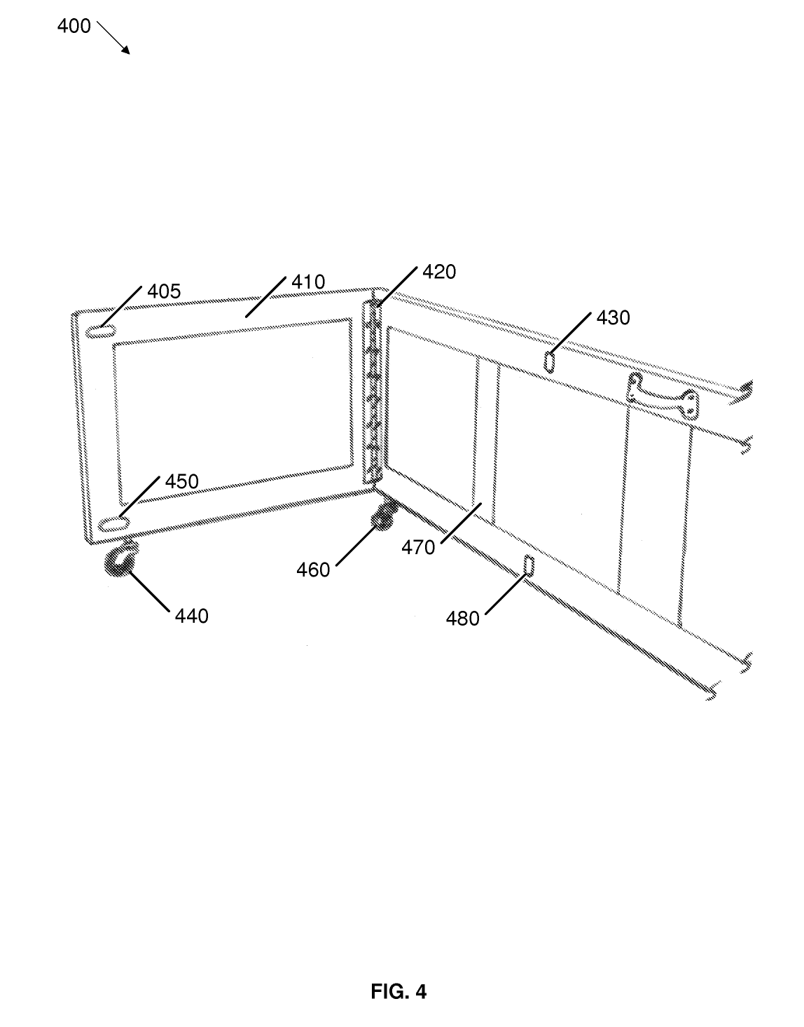

FIG. 4 displays a rear perspective view of an embodiment of a casket display apparatus 400. As shown in FIG. 4, casket display apparatus 400 has casters 440 and 460. In some alternative embodiments, different types of casters or rollers may be used. For example, one or more alternative embodiments may employ larger diameter wheels allowing casket display apparatus 400 to be freely wheeled around the casket at the gravesite without concern of mud or dirt caking up and restricting movement of the apparatus. Additionally, alternative embodiments may employ alternative elements to support the panels of casket display apparatus 400. For example, one embodiment may not employ casters or rollers at all, but employ a plurality of feet or legs, such as those support elements that may be found on furniture items, such as couches.

In even further embodiments, casket display apparatus 400 may have no wheels, rollers, or legs at all. For example, the bottoms of the front panel and the side panels may have a durable rubber strips affixed with glue or screws. Alternatively, each of the panels they have cleats, pads, or feet to support casket display apparatus 400. For example, an embodiment may have four or more small circular metal feet, with rubber faces for padding, attached to the bottoms of the panels. Two of the feet may be screwed into the front panel while each wing or side panel has one foot each. Depending on the embodiment, each of the feet may be screwed into and out of its respective panel to adjust the distance that casket display apparatus 400 rests above the ground or floor.

In the embodiment shown in FIG. 4, hinge 420 comprises a silver-plated pressed-metal hinge. In alternative embodiments, hinge 420 may be made from different metals and/or have different finishes. For example, hinge 420 may be made from brass, tin, or iron. Additionally, hinge 420 may be gold-plated, galvanized, et cetera. In even further embodiments, the hinges of casket display apparatus 400 may not be made from metal at all. For example, in some embodiments hinge 420 may be made from a durable plastic. Alternatively, in other embodiments, the hinges may comprise strips of cloth or canvas material.

In the embodiment depicted in FIG. 4, hinge 420 is attached to the inner surfaces of wing panel 410 and front panel 470 via fourteen wood screws. Other embodiments may attach hinge 420 to the panels using alternative means. For example, one embodiment may glue hinge 420 to each of front panel 470 and wing panel 410. In another embodiment, each of the metal plates of hinge 420 may be inserted into thin slots in the ends of wing panel 410 and front panel 470 in a “tongue-and-groove” fashion.

For the embodiment of casket display apparatus 400 shown in FIG. 4, the pin or hinge rod of hinge 420 is located at the edge of wing panel 410 but recessed from the edge of front panel 470. Constructed in this manner, hinge 420 allows wing panel 410 to rotate freely until opened to a 90° angle. In other words, wing panel 410 may rotate freely until perpendicular to front panel 470. Upon reaching the open position at 90°, the end of wing panel 410 butts up against front panel 470 and restricts any further movement or opening of wing panel 410. That is to say, having hinge 420 located along the edge of wing panel 410 yet recessed from the edge of front panel 470 allows first wing panel 410 to open until firmly stopped by front panel 470 when open to 90°. The corresponding hinge for a second wing panel, not shown in FIG. 4, allows it to operate in a similar manner.

In alternative embodiments, hinge 420 may restrict the movement of wing panel 410 in alternative ways or not at all. For example, in one embodiment hinge 420 may be constructed in such a fashion as to only allow travel or hinge operation from a fully closed position to a 90° open position. In other words, the hinge assembly itself may provide a mechanical restriction to stop the travel of the wing panel. In another embodiment, hinge 420 may pose no restriction for the movement of first wing panel 410 about the end of front panel 470. In such embodiments, a person may have to manually set the position of wing panel 410 relative to front panel 470 when placing casket display apparatus 400 about a mechanical structure supporting a casket. Alternatively, a sliding brace or cross-member may halt the movement of wing panel 410. For example, the sliding brace may comprise a long and slender strip of metal affixed at one end to the underside of wing panel 410 via a pin and affixed to front panel 470 via a sliding pin that slides along a groove cut in the underside of front panel 470 and stops travel of wing panel 410 when the sliding pin reaches an end of the groove.

In even further embodiments, movement of the wing panels may be restricted with springs. For example, one or more springs may be attached between wing panel 410 and front panel 470. The springs may automatically draw the wing panels in toward front panel 470. In these embodiments, a person may open the wing panels and push casket display apparatus 400 around the mechanical structure supporting the casket. Once in place, the springs may pull the wing panels into the mechanical structure whereupon latches or other mechanical fasteners may hold casket display apparatus 400 in place. Additionally, in further embodiments, the spring mechanisms may be integral to the hinges, such that the hinge tends to rotate the side panel toward the front panel. In even further embodiments, such integral hinge springs may tend to rotate the side panels away from the front panel until the side panels are perpendicular with the front panel. In other words, the springs of the hinges may help a person unfold the assemblage of panels and place them around the mechanical structure supporting the casket.

Wing panel 410 may fold toward front panel 470. When folded, casket display apparatus 100 may be more easily lifted and transported to different locations. To secure wing panel 410 during such transports, casket display apparatus 400 employs magnetic catch assemblies. For example, wing panel 410 has two securely attached magnetic catches, magnetic catch 405 and magnetic catch 450. When wing panel 410 is folded toward and comes in close proximity to front panel 470, magnetic catches 405 and 450 may come into contact with metal strike-plates 430 and 480, respectively, affixed to front panel 470 and secure wing panel 410 during transport.

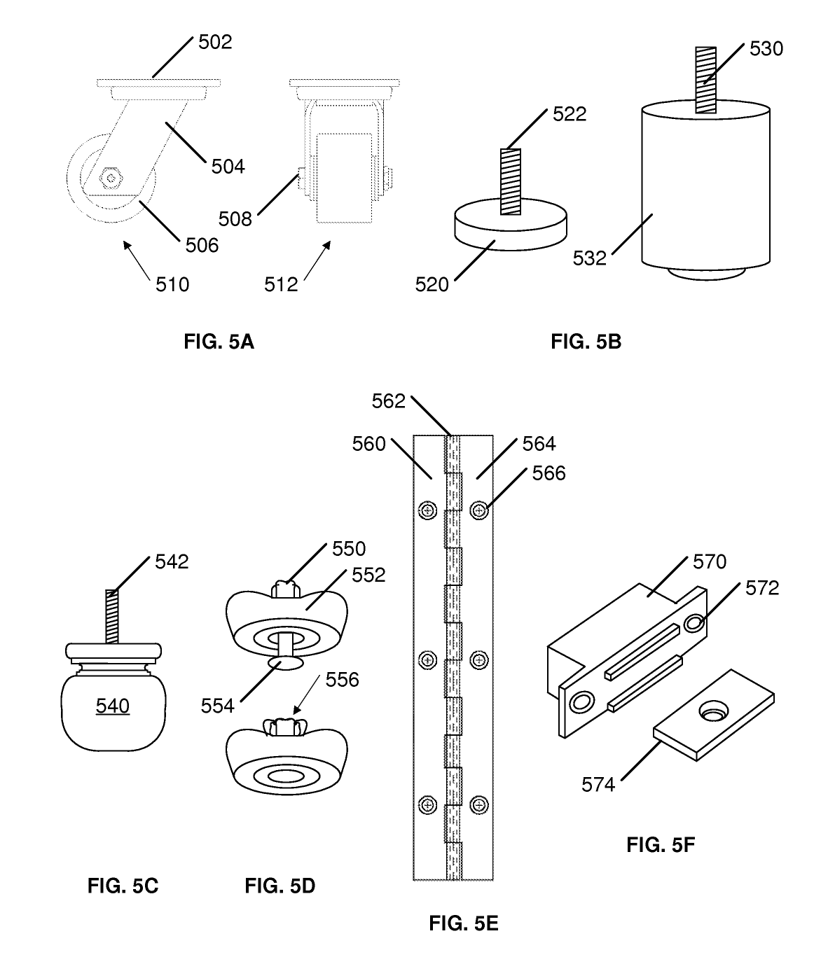

FIGS. 5A through 5F depict various components, including numerous support members, for one or more embodiments of a casket display apparatus. FIG. 5A shows a side view (element 510) and a front view (element 512) of a caster support member that may be used for one or more embodiments of a casket display apparatus. For example, the caster depicted in FIG. 5A may be used as one or more of casters 160, 170, 195, and casters 440 and 460, depicted in FIGS. 1 and 4, respectively. As shown in FIG. 5A, the caster has a rubber wheel 506 rotably coupled with a support-fork assembly 504 by way of an axle bolt-and-nut assembly 508. Support-fork assembly 504 is also rotably coupled with a base plate 502.

Base plate 502 may have numerous holes through which screws may attach the caster to the bottom of a panel of a casket display apparatus. For example, base plate 502 may have four holes through which four ¾″ wood screws may secure the caster to the bottom of a wooden panel. While numerous wheels 506 attached to the panel bottoms of a casket display apparatus may allow the apparatus to roll on a floor, having the support-fork assemblies rotably coupled with the base plates 502 may allow a person moving the apparatus to roll it in numerous directions.

In the different embodiments that employ one or more casters, such casters may vary from embodiment to embodiment in both mechanical arrangement and materials of construction. For example, while the embodiment of the caster depicted in FIG. 5A has a rubber wheel coupled with a chrome-plated metal rim alternative embodiments may employ solid rubber wheels or plastic wheels coupled with plastic rims or gold-plated metal rims. Further, while the embodiment of the caster depicted in FIG. 5A has a chrome-plated metal support-fork assembly alternative embodiments may employ polished brass or aluminum support-fork assemblies.

In an example of how the mechanical arrangement of casters may vary from embodiment to embodiment, base plate 502 may not be secured to the bottom of a panel with wood screws. Base plate 502 may instead be secured to the bottom of a panel using machine screws, such as when the panel is constructed using sheet metal or plastic. Alternatively, the casters may instead employ insertion rods that slide into holes drilled in the bottom of the panels. Even further, the casters may employ threaded insertion rods that screw into holes drilled in the bottom of the panels or into threaded sleeves inserted into the holes. Such alternative casters may also employ locking nuts, such that the heights of the panels can be adjusted by screwing the threaded insertion rods into and out of the threaded sleeves of the panels and locked via the locking nuts.

As described in the preceding discussions, a casket display apparatus may employ alternative support members or support means instead of casters. For example, an embodiment may use one caster for the outermost corner of each wing panel and support the front panel using a more decorative and aesthetically pleasing support leg or support foot. In other words, a person may lift the front panel and tilt the apparatus onto the two casters of the open wing panels when placing the apparatus around the mechanical support structure of the casket and lowering the front panel when the apparatus is in place. Alternatively, an embodiment may employ no casters at all and instead employed four or more legs. FIG. 5B shows an example of a threaded foot 520 and an example of a leg 532.

Foot 520 has a threaded insertion rod 522 that may be screwed into and out of a threaded sleeve in the bottom of a panel. When an embodiment employs numerous feet 520, each of which has a threaded insertion rod, the feet may be individually set to adjust the height that the panel rests above the floor. Foot 520 and threaded insertion rod 522 may be constructed using various materials. For example, foot 520 and/or threaded insertion rod 522 may comprise aluminum, wood, brass, or chrome-plated metal. Additionally, such feet may include rubber padding as well. Leg 532 comprises a cylindrical piece of wood that may be secured to the bottom of the panel via threaded insertion rod 530. Leg 532 may also vary from embodiment to embodiment. For example, leg 532 may comprise a wooden and uniform-sized square leg in one embodiment yet comprise a wooden tapered leg and another embodiment. In other words, leg 532 may be wider on the end near threaded insertion rod 530 than on the end that rests on the floor.

FIG. 5C depicts a bun foot 540 having a threaded insertion rod 542. Bun foot 540 may be used as an alternative support member to foot 520 and/or leg 532 in one or more embodiments. For example, an embodiment may employ four bun feet 540 on a front panel, with two casters attached to the two wing panels. FIG. 5D depicts an even further alternative to foot 520. For one or more embodiments, a person may construct a casket display apparatus using foot 552, or a plurality thereof. For example, a person may drill three holes into the bottom of a front panel to accommodate three feet 552. The person may insert the anchor-wedge assembly 550 into a hole and the press pin 554 causing the anchor-wedge assembly 550 to spread once inserted in the hole (element 556). Using a plurality of feet 552 in such a manner may allow a person to assemble a casket display apparatus in a more rapid fashion than using threaded casters, feet, or legs.

FIG. 5E depicts an example hinge that may couple panels in an assemblage of panels and allow the panels to rotate so that the apparatus may be placed around a mechanical structure supporting the casket, or allow the panels to collapse for transporting the apparatus. For example, hinge 360 and/or hinge 420, shown in FIGS. 3 and 4, respectively, may comprise a hinge like the one depicted in FIG. 5E. The hinge of FIG. 5E comprises a first wing plate 560 coupled to a second wing plate 564 via a pin 562. The hinge depicted in FIG. 5E comprises a non-self closing hinge. Alternative embodiments may employ other types of hinges, such as self closing hinges, concealed hinges, semi-concealed hinges, slip on hinges, and/or snap closing hinges, as examples.

The hinge depicted in FIG. 5E has six screw holes, such as screw hole 566, for attaching the hinge to the panels. For example, hinge 420 may comprise the hinge depicted in FIG. 5E, attached to both wing panel 410 and front panel 470 in FIG. 4. In different embodiments the lengths of the hinges employed may vary. For example, one embodiment may employ a single hinge measuring approximately sixteen inches in length, measured from the top of the panels to the bottom. Another embodiment may employ two hinges, one at the top of the panels and one at the bottom, each hinge measuring approximately three inches.

FIG. 5F depicts a magnetic catch assembly, comprising a magnetic catch 570 with metal strike-plate 574, that may be used in one or more embodiments. For example, any one of magnetic catch 130 shown in FIG. 1, magnetic catch 220 and/or magnetic catch 230 shown in FIG. 2, and magnetic catches 405 and 450 shown in FIG. 4 may comprise a magnetic catch like or similar to magnetic catch 570. In other words, magnetic catch 570 may be inserted into a recessed opening cut into a panel and provide a fastening means to secure the panel from movement whenever the panel is brought within close proximity to strike-plate 574, such as strike-plate 430 shown in FIG. 4. Both strike-plate 574 and magnetic catch 570 may be affixed to its respective panel by way of wood screws inserted through one or more holes of the elements, such as hole 572.

The sizes, numbers, shapes, mounting locations, and materials of construction of magnetic catch 570 and metal strike-plate 574 may vary from embodiment to embodiment. For example, the embodiment of casket display apparatus 400 shown in FIG. 4 has two magnetic catches, magnetic catches 405 and 450, mounted in wing panel 410 and securing wing panel 410 to front panel 470 whenever wing panel 410 is folded toward front panel 470 such that magnetic catches 405 and 450 latch to strike-plates 430 and 480, respectively. An alternative embodiment may employ three magnetic catches mounted in front panel 470 that latch to three strike-plates affixed to wing panel 410 whenever wing panel 410 is brought within close proximity to front panel 470. Additionally, in even further embodiments, the casket display apparatuses may employ no magnetic catches at all. For example, a casket display apparatus may instead secure a wing or side panel to another panel using an alternate fastening means, such as by using one or more cabinet latches, grabber catch latches, snap latches, or hook and loop fasteners.

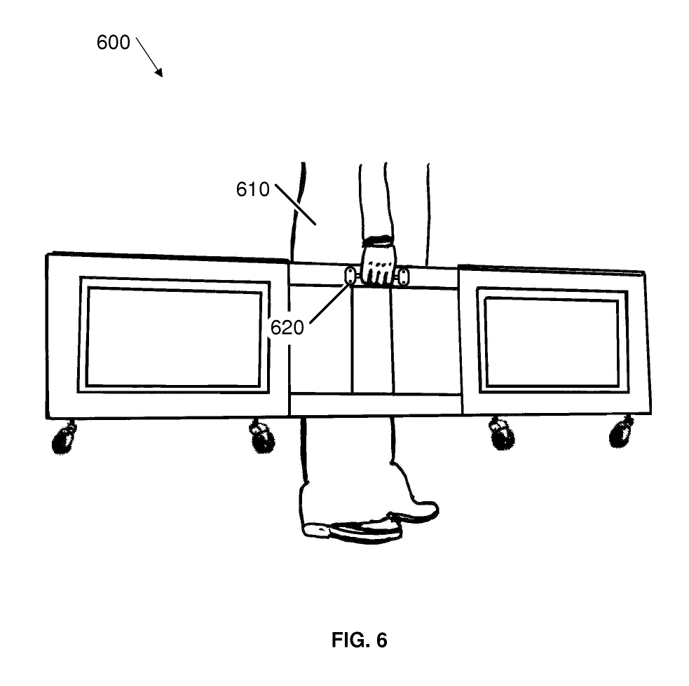

FIG. 6 illustrates how a person 610 may easily transport a fully collapsed casket display apparatus 600. As shown in the illustration, person 610 is lifting casket display apparatus 600 with his right hand using handle 620. Being able to fold or collapse casket display apparatus 600 in this manner, may allow a person to more easily transport casket display apparatus 600 from a funeral home or a church to the hearse and the gravesite, and vice versa. Additionally, casket display apparatus 600 may be easily moved from one room to another in a church or the funeral home, as well as being stored away out of sight when not in use.

The embodiment of casket display apparatus 600 depicted in FIG. 6 has a weight of 35 pounds and measures approximately 18 inches tall and 72 inches across the width of the front panel. When collapsed, casket display apparatus 600 has an approximate width of two and half inches. Alternative embodiments may weigh more or less depending on the overall dimensions and materials used. For example, an alternative embodiment of casket display apparatus 600 may have been constructed from vinyl, filled with Styrofoam™, and measure 24 inches in height but have a weight of only 25 pounds.

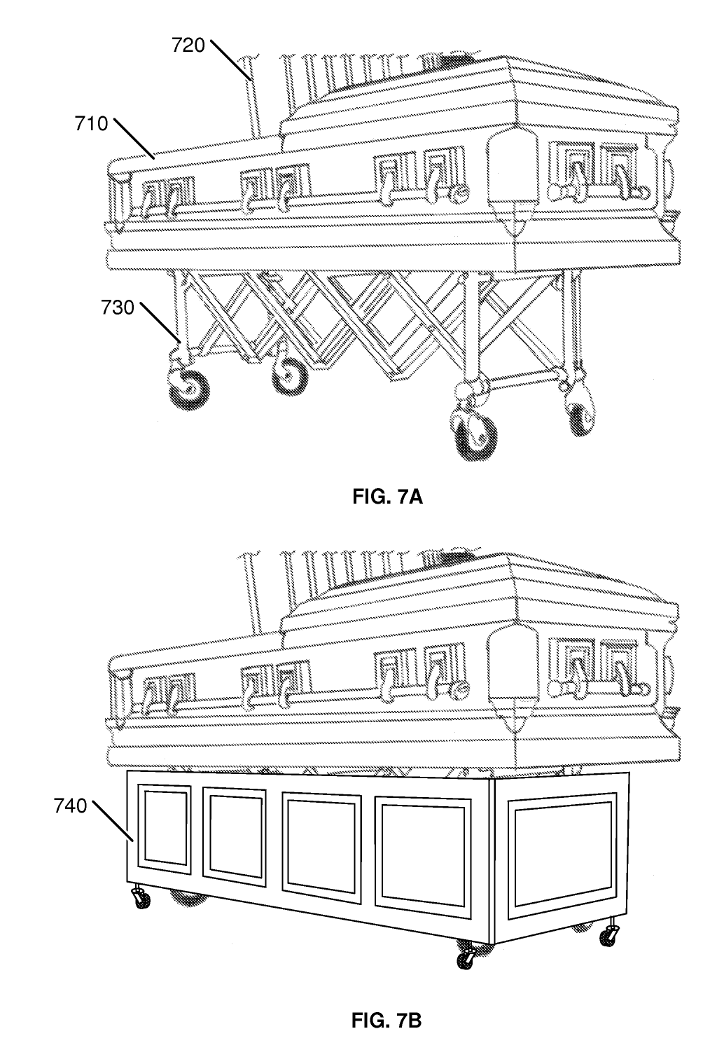

FIG. 7A and FIG. 7B illustrate how an embodiment of a casket display apparatus or an assemblage of panels 740, may conceal a mechanical structure 730 supporting a casket 710. As FIG. 7A illustrates, casket 710 may be open (element 720) during a church or graveside service. Also as FIG. 7A illustrates, mechanical structure 730 may comprise a casket truck or some other support assembly, such as a pedestal, a show-room truck, a bier, a church truck, or some other support assembly.

Mechanical structure 730 may support casket 710 at an appropriate height for viewing during the service. However, mechanical structure 730 may be considered unsightly whereupon the church or the funeral home may want to conceal mechanical structure 730 during the service. To conceal the mechanical support of casket 710, a funeral director or other person involved in the service may carry or otherwise transport the assemblage of panels 740 to the location of the service, unfold the assemblage of panels 740, and place the assemblage of panels 740 about the mechanical support to display the casket in a more attractive manner. For example, the funeral director may unfold each of the wing panels of the assemblage of panels 740 until they are both perpendicular to the front panel of the assemblage of panels 740. Once opened, the funeral director may then roll the assemblage of panels 740 toward casket 710 and mechanical structure 730 until the assemblage of panels 740 rests under casket 710 and hides or conceals mechanical structure 730, as illustrated in FIG. 7B.

Upon conclusion of the service, the funeral director or other person may roll the assemblage of panels 740 away from casket 710 and mechanical structure 730, fold both of the wing panels back toward the front panel until the wing panels are secured against front panel. Once both of the wing panels are secured, the funeral director may lift the assemblage of panels 740 and transport the assemblage of panels 740 away from the location of the service. Leaving casket 710 on mechanical structure 730 in this manner may eliminate the need to lift casket 710 from mechanical structure 730 and place casket 710 onto a casket bier for the service. Eliminating the need to place casket 710 on the casket bier, and to place casket 710 back onto mechanical structure 730, may improve the safety of funeral workers or other people lifting casket 710. For example, using the assemblage of panels 740 to display casket 710 during the service, instead of a casket bier, may reduce the number of times that casket 710 is moved. Reducing the number of times that casket 710 is moved may help prevent pulled muscles, back injuries, etc.

FIG. 7A and FIG. 7B also illustrate how an assemblage of panels 740 may be combined with a mechanical structure 730 to form an embodiment of a casket display system. In one more embodiments, assemblage of panels 740 may be specifically designed to attach or adhere to mechanical structure 730. For example, assemblage of panels 740 may have a plurality of mechanical supports affixed to the interior sides of the panels such that the mechanical supports attached to and possibly allow the assemblage to hang from mechanical structure 730. That is to say, assembly of panels 740 may have a number of latches that couple with correspondingly located catch assemblies affixed to mechanical structure 730, such that assemblage of panels 740 may couple to mechanical structure 730 instead of only resting near mechanical structure 730. In such embodiments, assemblage of panels 740 may have no need for casters, feet, or legs, as assemblage of panels 740 may be supported by mechanical structure 730.

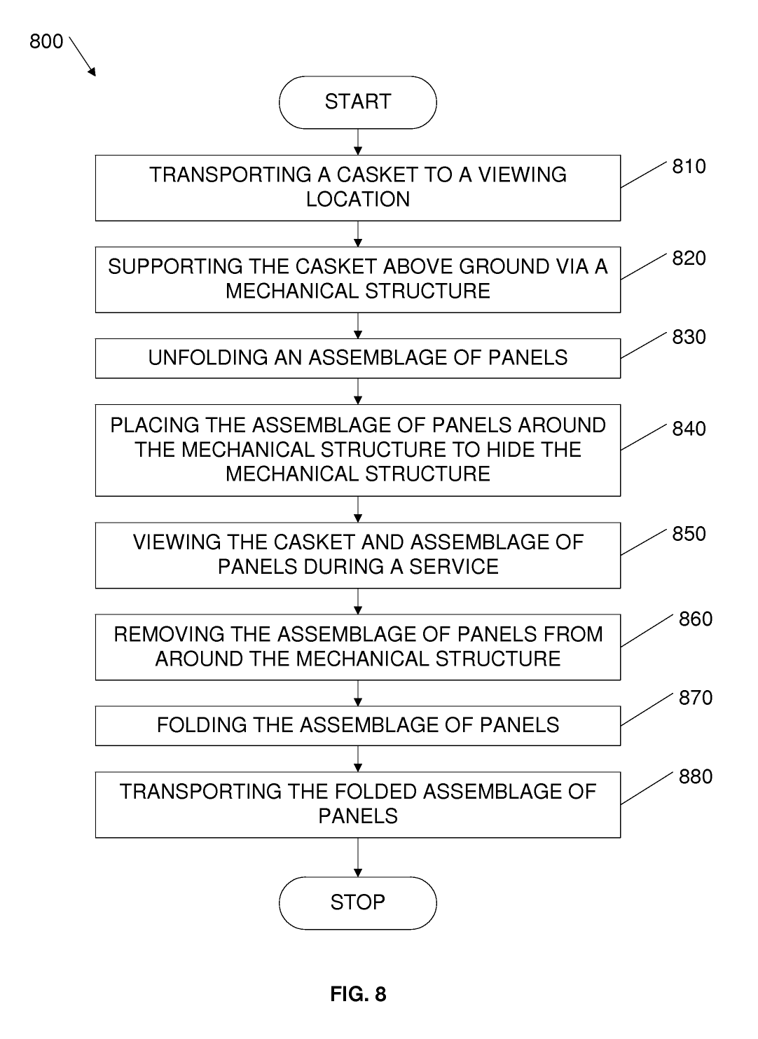

FIG. 8 illustrates a flowchart 800 of a method for using an assemblage of panels to hide a mechanical structure supporting a casket. An embodiment according to flowchart 800 begins with transporting a casket to a viewing location (element 810). For example, a pastor involved with a church service may have the casket supported on a church truck. The pastor may want to move the casket from a room located in the rear of the church to another room in which the church service will be conducted. While the casket is on the church truck (element 820), the pastor may push the casket and church truck into the room of the service.

An embodiment according to flowchart 800 continues by unfolding an assemblage of panels (element 830). Continuing with our previous example, the pastor may use a carrying handle attached to an assemblage of panels to carry the assemblage to the room housing the church truck and casket, as illustrated in FIG. 6. Once the pastor has transported the assemblage of panels to the room housing the church truck and casket, the pastor may then unfold two wing panels away from a single front panel in preparation for placing the assemblage of panels around the church truck, similar to the manner illustrated by FIG. 2.

A method according to flowchart 800 may proceed by placing the assemblage of panels around the mechanical structure to hide it (element 840) and viewing the casket and assemblage of panels during a service (element 850). Again, continuing with our previous example, the pastor may place the unfolded assemblage of panels around the church truck and subsequently conduct the service. Once the service is over, the assemblage of panels may be removed from around the mechanical structure (element 860), folded for transport (element 870), and transported away from the service for storage or subsequent use (element 880). Continuing with our example, the pastor may remove the assemblage of panels from around the church truck, fold the two wing panels toward the front panel until each are secured to the front panel using magnetic catches or other types of latches or fastening means, and carry the folded assemblage of panels to a storage room in the back of the church until the folded assemblage is needed again for another service.

It will be apparent to those skilled in the art having the benefit of this disclosure that the embodiments herein contemplate methods for displaying caskets, as well as casket display apparatuses. It is understood that the form of the embodiments shown and described in the detailed description and the drawings are to be taken merely as examples. It is intended that the appended claims be interpreted broadly to embrace all the variations of the embodiments disclosed.

Although some aspects have been described in detail for some embodiments, it should be understood that various changes, substitutions and alterations can be made herein without departing from the spirit and scope of the embodiments as defined by the appended claims. Although one embodiment may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the embodiments, processes, machines, manufacture, compositions of matter, means, methods, or steps, presently existing or later to be developed that perform substantially the same function to achieve substantially the same result as the corresponding embodiments described herein may be utilized according to the embodiments herein. Accordingly, the appended claims are intended to include within their scope such processes, machines, manufacture, compositions of matter, means, methods, or steps.

What is claimed is:

1. A method of presenting a casket for display, comprising:
supporting the casket above a ground elevation via a mechanical structure; and
placing an assemblage of panels around at least a portion of the mechanical structure, wherein the assemblage of panels is foldable.

2. The method of claim 1, further comprising unfolding the assemblage of panels to place the assemblage, wherein the unfolding comprises moving a wing panel away from a front panel.

3. The method of claim 2, wherein the moving comprises rotating the wing panel about a hinge, wherein further the hinge couples the wing panel to the front panel.

4. The method of claim 1, further comprising folding the assemblage to allow transport of the assemblage.

5. The method of claim 1, wherein the supporting the casket above the ground elevation comprises supporting the casket via a casket truck in one of a church and a funeral home.

6. The method of claim 5, wherein the placing the assemblage comprises rolling the assemblage on a plurality of casters affixed to the assemblage, wherein further the placing is to prevent lifting the casket to prevent injuries to people lifting the casket.

7. The method of claim 1, wherein the placing the assemblage comprises placing the assemblage between the mechanical structure and viewers of the casket to at least partially hide the mechanical structure.

8. An apparatus for displaying a casket, comprising:
a front panel;
a first wing panel attached to the front panel via a first hinge; and
a second wing panel attached to the front panel via a second hinge, wherein the first and second hinges allow the first and second wing panels to swing away from the front panel so that the apparatus may be placed around a mechanical structure supporting the casket, wherein further the first and second hinges allow the first and second wing panels to swing toward the front panel and collapse for transporting the apparatus.

9. The apparatus of claim 8, further comprising at least two casters attached to the front panel to allow the apparatus to roll on a floor.

10. The apparatus of claim 9, further comprising a first caster attached to the first wing panel and a second caster attached to the second wing panel.

11. The apparatus of claim 9, wherein the at least two casters are adjustable to change the distance between the apparatus and the floor.

12. The apparatus of claim 8, further comprising at least one of a plurality of feet, a plurality of legs, a plurality of threaded casters, a threaded foot, a threaded leg, and a bun foot to allow the apparatus to be supported above one of a ground and a floor.

13. The apparatus of claim 8, further comprising a first latch for the first wing panel and a second latch for the second wing panel, wherein the first latch and the second latch allow the first and second wing panels to be secured to the front panel.

14. The apparatus of claim 13, wherein the first and second latches comprise magnetic catches.

15. An apparatus for displaying a casket, comprising:
an assemblage of a plurality of panels, wherein at least one panel of the plurality of panels is arranged to fold to allow for transport of the assemblage, wherein further the at least one panel of the plurality of panels may unfold to conceal a mechanical support of the casket from viewers of the casket.

16. The apparatus of claim 15, further comprising at least one fastener to secure the at least one panel during the transport.

17. The apparatus of claim 16, wherein the fastener comprises a hook and loop fastener.

18. The apparatus of claim 15, further comprising at least one hinge to allow the folding.

19. The apparatus of claim 15, further comprising a plurality of support members to separate the assemblage from one of a ground and a floor.

20. The apparatus of claim 19, wherein the plurality of support members comprises at least one caster.
